(19) United States
(12) Patent Application Publication
(10) Pub. No.: US 2024/0339253 A1
(43) Pub. Date: Oct. 10, 2024

(54) MAGNETIC ATTRACTION STRUCTURE AND VEHICLE-MOUNTED BRACKET

(71) Applicant: GOPOD GROUP HOLDING LIMITED., Shenzhen (CN)

(72) Inventor: Zhuowen LIAO, Shenzhen (CN)

(21) Appl. No.: 18/340,960

(22) Filed: Jun. 26, 2023

(30) Foreign Application Priority Data
Apr. 7, 2023 (CN) 202310404138.7

(51) Int. Cl. H01F 7/02; B60R 11/02

(52) U.S. Cl. CPC H01F 7/02; B60R 11/0241; B60R 2011/0008; B60R 2011/0057; B60R 2011/0059

(57) ABSTRACT

The invention belongs to the technical field of electronic product accessories, and particularly relates to a magnetic attraction structure and a vehicle-mounted bracket. The magnetic attraction structure comprises: a first magnetic attraction assembly, which comprises a first housing provided with an accommodating cavity and a plurality of first magnetic strips arranged in the accommodating cavity, the first housing being provided with an opening communicated with the accommodating cavity, and the first magnetic strips being annularly arranged at intervals in sequence; and a second magnetic attraction assembly, which comprises a second housing located at the opening and a plurality of second magnetic strips connected with the second housing, the second magnetic strips being annularly arranged at intervals in sequence, and a magnetic pole of the first magnetic strip and a magnetic pole of the second magnetic strip being arranged oppositely.

### CROSS-REFERENCE TO RELATED APPLICATIONS

This application claims priority to the patent for utility model with the application No. 202310404138. 7, titled “MAGNETIC ATTRACTION STRUCTURE AND VEHICLE-MOUNTED BRACKET”, and filed on Apr. 7, 2023 to the China National Intellectual Property Administration, the entire contents of which are incorporated herein by reference.

### TECHNICAL FIELD

The present invention belongs to the technical field of electronic product accessories, and particularly relates to a magnetic attraction structure and a vehicle-mounted bracket.

### BACKGROUND OF THE PRESENT INVENTION

With the rapid popularization of intelligent terminal devices and the continuous improvement of people's living standards, mobile terminals such as tablet computers and mobile phones have become indispensable electronic devices in people's daily lives. During driving, drivers often use the mobile terminals for navigation. In order to facilitate the viewing of the mobile terminals, it is necessary to support the mobile phone in a control compartment by a vehicle-mounted bracket.

Current mobile phones have a function of wireless charging, and an annular magnet structure may be applied inside the mobile phones. Moreover, the annular magnet structure may also be arranged in a magnetic attraction structure of the vehicle-mounted bracket. The mobile phone is fixed on the vehicle-mounted bracket through a magnetic attraction effect between the magnet structure of the mobile phone and the magnet structure of the vehicle-mounted bracket, so that the mobile phone is fixed and supported by the vehicle-mounted bracket.

However, when the mobile phone is taken down from the vehicle-mounted bracket, it is not necessary to arrange a magnet to provide a strong magnetic attraction force between the magnetic attraction structure and the mobile phone. An excessive magnetic attraction force may cause a trouble process of taking down the mobile phone, and the mobile phone usually needs to be taken down with both hands at the same time, which, especially for a driver who is driving, increases a danger of driving.

### SUMMARY OF PRESENT INVENTION

Embodiments of the present application are intended to provide a magnetic attraction structure, aiming at solving the problem about how to improve use convenience of the magnetic attraction structure.

In order to achieve the above object, technical solutions used in the present application are as follows.

In a first aspect, a magnetic attraction structure is provided, which comprises:
a first magnetic attraction assembly, which comprises a first housing provided with an accommodating cavity and a plurality of first magnetic strips arranged in the accommodating cavity, wherein the first housing is provided with an opening communicated with the accommodating cavity, and the first magnetic strips are annularly arranged at intervals in sequence; and a second magnetic attraction assembly, which comprises a second housing located at the opening and a plurality of second magnetic strips connected with the second housing, wherein the second magnetic strips are annularly arranged at intervals in sequence, and a magnetic pole of the first magnetic strip and a magnetic pole of the second magnetic strip are arranged oppositely; wherein, the first housing is provided with a first position state and a second position state; when the first housing is in the first position state, the second housing moves towards an exterior of the accommodating cavity by a predetermined distance, so that the first magnetic strips and the second magnetic strips are arranged at intervals along a moving direction; and when the first housing is in the second position state, the first housing moves towards an interior of the accommodating cavity by a predetermined distance, so that the first magnetic strips and the second magnetic strips are spliced into a magnetic attraction ring, and the first magnetic strips and the second magnetic strips are alternately arranged in sequence.

In some embodiments, a shape of the magnetic attraction ring at least comprises one of a circle, an ellipse and a polygon.

In some embodiments, a length of the first magnetic stripe is equal to a length of the second magnetic stripe.

In some embodiments, the magnetic attraction structure further comprises an elastic member with an elastic restoring force, one end of the elastic member is connected with a cavity bottom of the accommodating cavity, and the other end of the elastic member is connected with the second housing; and when the first housing is switched from the first position state to the second position state, the first housing compresses the elastic member.

In some embodiments, the elastic member is a tubular spring, and the first magnetic strips or the second magnetic c strips are circumferentially arranged along the elastic member.

In some embodiments, the magnetic attraction structure further comprises a pushing switch, a pushing end of the pushing switch is connected with the first housing, a main body end of the pushing switch is connected with the second housing, the pushing switch is provided with a locked state and an unlocked state, and the first housing is in the first position state and the pushing switch is in the unlocked state; and the pushing switch is in the locked state and the first housing is in the second position state.

In some embodiments, the magnetic attraction structure further comprises a buckling mechanism, the buckling mechanism comprises a first buckling portion connected with the first housing and a second buckling portion connected with the second housing, and when the first housing is in the second position state, the first buckling portion is bucked with the second buckling portion.

In some embodiments, the first magnetic attraction assembly further comprises a first magnetic conducting ring, the first magnetic strips are arranged at an edge of an inner ring of the first magnetic conducting ring and located between the cavity bottom of the accommodating cavity and the first magnetic conducting ring, the first magnetic conducting ring is also provided with an avoidance gap for the second magnetic strip to pass through, and the avoidance gap is arranged between any two adjacent first magnetic strips.

In some embodiments, the second magnetic attraction assembly further comprises a second magnetic conducting ring connected with the second housing, and the second magnetic stripes are arranged on the second magnetic conducting ring.

In a second aspect, a vehicle-mounted bracket is provided, which comprises the magnetic attraction structure.

The present application has the beneficial effects that: the magnetic attraction structure comprises the first magnetic attraction assembly and the second magnetic attraction assembly, when the first housing is in the first position state, the first magnetic stripes are magnetically connected with a mobile phone located on a magnetic attraction surface, and when the first housing is switched into the second position state, the first magnetic stripes and the second magnetic stripes are spliced and alternately arranged, so that a magnetic attraction force between the mobile phone and the first magnetic stripes is reduced, thus being convenient to take down the mobile phone from the magnetic attraction surface, and improving use convenience and safety of the magnetic attraction structure.

### DESCRIPTION OF THE DRAWINGS

In order to illustrate technical solutions in embodiments of the present application more clearly, the drawings which need to be used in describing the embodiments or the exemplary technology will be briefly introduced hereinafter. Apparently, the drawings described hereinafter are only some embodiments of the present application, those of ordinary skills in the art may obtain other drawings according to these drawings without going through any creative work.

FIG. 1 is a schematic diagram of a stereoscopic structure of a magnetic attraction structure provided by an embodiment of the present application;

FIG. 2 is an exploded view of the magnetic attraction structure in FIG. 1;

FIG. 3 is a cross-sectional view of a first housing of the magnetic attraction structure in FIG. 1 in a first position state;

FIG. 4 is a cross-sectional view of a first housing of a magnetic attraction structure in another embodiment in a second position state; and

FIG. 5 is a schematic structural diagram of a magnetic attraction ring formed by splicing first magnetic strips and second magnetic strips in FIG. 4.

Reference numerals in the drawings are as follows:
300 refers to magnetic attraction structure; 100 refers to first magnetic attraction assembly; 200 refers to second magnetic attraction assembly; 201 refers to second housing; 202 refers to second magnetic conducting ring; 203 refers to second magnetic stripe; 400 refers to elastic member; 101 refers to first housing; 102 refers to first magnetic conducting ring; 103 refers to first magnetic stripe; 104 refers to avoidance gap; 105 refers to accommodating cavity; 106 refers to opening; 500 refers to magnetic attraction ring; and 110 refers to magnetic attraction surface.

### DETAILED DESCRIPTION OF PREFERRED EMBODIMENTS

To make the objects, the technical solutions, and the advantages of the present application clearer, the present application is further described in detail hereinafter with reference to the drawings and the embodiments. It shall be understood that the specific embodiments described herein are only used for explaining the present application and are not intended to limit the present application.

It should be noted that when an element is expressed to be “fixed” or “arranged” on another element, it may be directly or indirectly on another element. When one element is referred to being “connected” to another element, it may be directly or indirectly connected to another element. The orientation or position relationship indicated by the terms “up”, “down”, “left”, “right”, and the like is based on the orientation or position relationship shown in the drawings, it is only for the convenience of description, and it is not to indicate or imply that the indicated device or element must have a specific orientation, and be constructed and operated in a specific orientation. Therefore, the terms should not be understood as limiting the present application. For those of ordinary skills in the art, specific meanings of the above terms may be understood according to specific situations. The terms “first” and “second” are only used for descriptive purposes, but cannot be understood as indicating or implying relative importance, or implicitly indicating the number of technical features. The meaning of “multiple” is two or more than two, unless otherwise specifically defined.

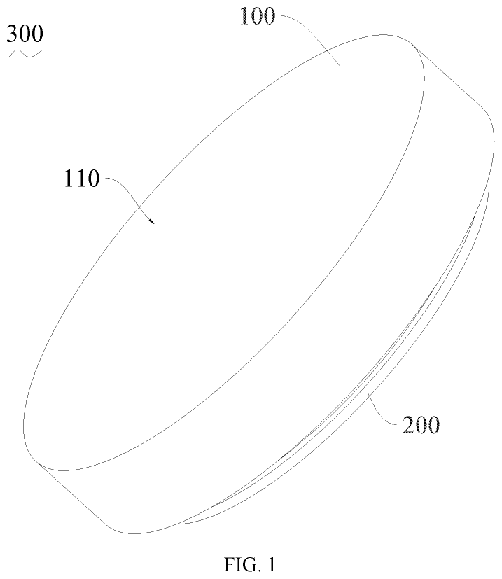

With reference to FIG. 1 to FIG. 3, an embodiment of the present application provides a magnetic attraction structure 300 and a vehicle-mounted bracket provided with the magnetic attraction structure. The magnetic attraction structure 300 is detachably connected with a mobile phone by a magnetic attraction effect. It is understandable that, an interior of the mobile phone is provided with a magnet, or the interior of the mobile phone is provided with a structural member capable of magnetically attracting the magnet, such as metallic iron, so that the magnetic attraction effect is capable of being generated with the magnetic attraction structure 300. In the embodiment, the interior of the mobile phone is provided with the magnet, a plurality of magnets are provided, and the magnets are annularly arranged. In other embodiments, the mobile phone may also be replaced with other electronic products, which is not limited herein and may be selected according to actual situations.

With reference to FIG. 1 to FIG. 3, the magnetic attraction structure 300 comprises a first magnetic attraction assembly 100 and a second magnetic attraction assembly 200. The first magnetic attraction assembly 100 comprises a first housing 101 provided with an accommodating cavity 105 and a plurality of first magnetic strips 103 arranged in the accommodating cavity 105. The first housing 101 is provided with an opening 106 communicated with the accommodating cavity 105, the first magnetic stripes 103 are annularly arranged at intervals in sequence at a cavity bottom of the accommodating cavity 105, which means that the first magnetic stripes 103 are circumferentially arranged around a center position of the cavity bottom of the accommodating cavity 105, and adapted to the magnets arranged on the mobile phone. The first housing 101 is further provided with a magnetic attraction surface 110, and the magnetic attraction surface 110 is arranged opposite to the opening 106. The mobile phone is placed on the magnetic attraction surface 110, and setting of a magnetic pole of the magnet in the mobile phone is adapted to setting of a magnetic pole of the first magnetic strip 103, so that the mobile phone is capable of being detachably fixed on the first housing 101 due to the magnetic attraction effect between the mobile phone and the first magnetic strips 103. It is understandable that, the first magnetic stripe 103 is capable of generating a magnetic field, and may be a static magnet, a constant magnet or a permanent magnet.

The second magnetic attraction assembly 200 comprises a second housing 201 located at the opening 106 and a plurality of second magnetic strips 203 connected with the second housing 201, and the second housing 201 is movably arranged at the opening 106. The second magnetic strips 203 are annularly arranged at intervals in sequence, and the magnetic pole of the first magnetic strip 103 and a magnetic pole of the second magnetic strip 203 are arranged oppositely. A projection of any second magnetic stripe 203 on the cavity bottom of the accommodating cavity 105 is located between two adjacent first magnetic stripes 103. It is understandable that, the second magnetic stripe 203 is capable of generating a magnetic field, and may be a static magnet, a constant magnet or a permanent magnet.

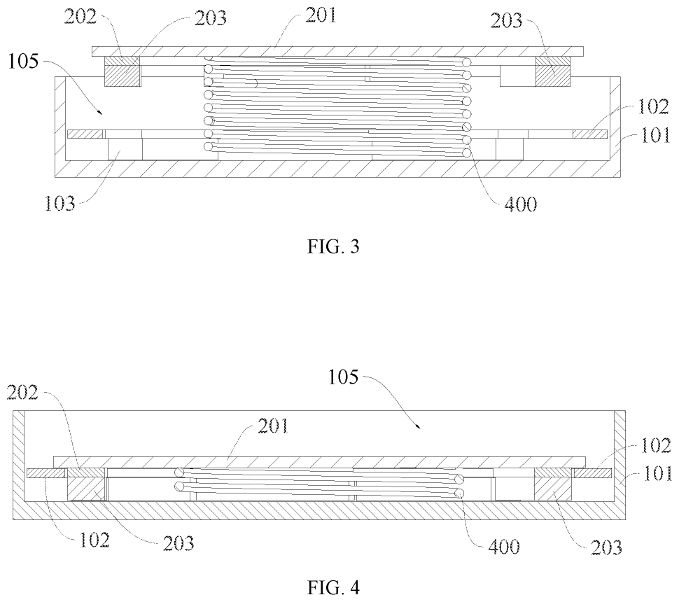

With reference to FIG. 3 to FIG. 5, the first housing 101 is provided with a first position state and a second position state. When the first housing 101 is in the first position state, the mobile phone is placed on the magnetic attraction surface 110, and the first housing 101 moves in a direction far away from the second housing 201, that is, the second housing 201 moves towards an exterior of the accommodating cavity 105 by a predetermined distance relative to the first housing 101, so that the first magnetic strips 103 and the second magnetic strips 203 are arranged at intervals along a moving direction, thus avoiding the second magnetic stripes 203 from interfering with magnetic attraction connection between the first magnetic stripes 103 and the mobile phone, and making the first magnetic stripes 103 maintain a sufficient magnetic attraction force to the mobile phone. When the first housing 101 is in the second position state, the first housing 101 moves in a direction close to the second housing 201, that is, the first housing 101 moves towards an interior of the accommodating cavity 105 by a predetermined distance, so that the first magnetic strips 103 and the second magnetic strips 203 are spliced into a magnetic attraction ring 500, and the first magnetic strips 103 and the second magnetic strips 203 are alternately arranged in sequence. It is understandable that, the magnetic fields of the second magnetic strips 203 interfere with the magnetic fields of the first magnetic strips 103 respectively, and disturb the magnetic fields of the first magnetic strips 103, so as to reduce an overall magnetic field strength of the magnetic attraction ring 500, thus reducing the magnetic attraction force between the mobile phone and the first magnetic strips 103, and being convenient to take down the mobile phone from the magnetic attraction surface 110. It is also understandable that, there is an attraction force between the first magnetic stripes 103 and the mobile phone, and there is a repulsion force between the second magnetic stripes 203 and the mobile phone, thus reducing the magnetic attraction force between the mobile phone and the first magnetic stripes 103.

With reference to FIG. 1 to FIG. 3, the magnetic attraction structure 300 provided by the embodiment comprises the first magnetic attraction assembly 100 and the second magnetic attraction assembly 200, when the first housing 101 is in the first position state, the first magnetic stripes 103 are magnetically connected with the mobile phone located on the magnetic attraction surface 110, and when the first housing 101 is switched into the second position state, the first magnetic stripes 103 and the second magnetic stripes 203 are spliced and alternately arranged, so that the magnetic attraction force between the mobile phone and the first magnetic stripes 103 is reduced, thus being convenient to take down the mobile phone from the magnetic attraction surface 110, and improving use convenience and safety of the magnetic attraction structure 300.

Optionally, when the first housing 101 is in the second position state, the first magnetic strips 103 and the second magnetic strips 203 are all located on the same plane.

It is understandable that, during use, the first housing 101 is a movable member, and the second housing 201 is a fixed member.

It is understandable that, the mobile phone may also be arranged on the second housing 201, which is not limited herein and may be selected according to actual situations.

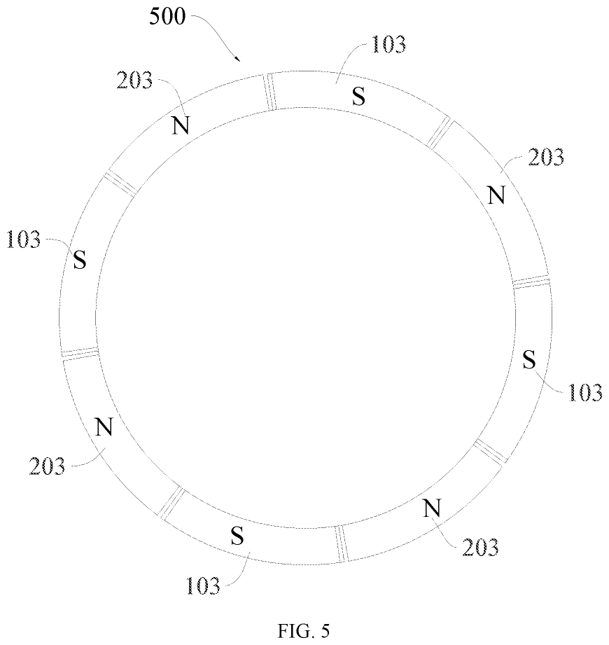

Optionally, in the embodiment, four first magnetic strips 103 and four second magnetic strips 203 are provided, and the magnetic poles of the first magnetic strips 103 and the magnetic poles of the second magnetic strips 203 are arranged as shown in FIG. 5.

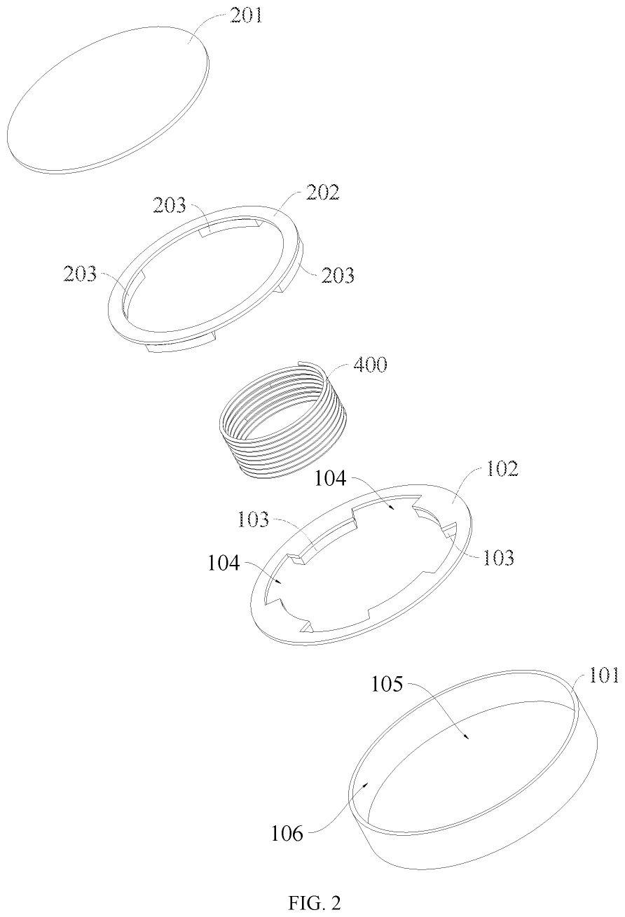

With reference to FIG. 2 to FIG. 4, in some embodiments, a shape of the magnetic attraction ring 500 at least comprises one of a circle, an ellipse and a polygon. In the embodiment, the shape of the magnetic attraction ring 500 is the circle, and a shape of the first magnetic stripe 103 and a shape of the second magnetic stripe 203 are both an arc. In other embodiments, the shape of the magnetic attraction ring 500 may also be the polygon or the ellipse, which is not limited herein and may be selected according to actual situations.

It is understandable that, the first magnetic strips 103 are circularly arranged at intervals in sequence, the second magnetic strips 203 are circularly arranged at intervals in sequence, and centers of the two circles are coincident.

With reference to FIG. 2 to FIG. 4, in some embodiments, a length of the first magnetic stripe 103 is equal to a length of the second magnetic stripe 203. Optionally, in the embodiment, the shape of the first magnetic stripe 103 and the shape of the second magnetic stripe 203 are both the arc, and the length of the first magnetic stripe 103 and the length of the second magnetic stripe 203 both refer to a length of the arc.

With reference to FIG. 2 to FIG. 4, in some embodiments, the magnetic attraction structure 300 further comprises an elastic member 400 with an elastic restoring force, one end of the elastic member 400 is connected with the cavity bottom of the accommodating cavity 105, and the other end of the elastic member 400 is connected with the second housing 201; and when the first housing 101 is switched from the first position state to the second position state, the first housing 101 compresses the elastic member 400. It is understandable that, when the first housing 101 is in the first position state, the elastic member 400 is naturally stretched. When the mobile phone needs to be taken down, an operator may hold the mobile phone and press the first housing 101 towards the second housing 201 until the second magnetic strips 203 are spliced in place with the first magnetic strips 103 and the elastic member 400 is in a compressed state. At the moment, the mobile phone may be conveniently taken down from the magnetic attraction surface 110, and then the elastic member 400 is restored to an original state to drive the first housing 101 to be switched into the first position state.

With reference to FIG. 2 to FIG. 4, in some embodiments, the elastic member 400 is a tubular spring, and the first magnetic strips 103 or the second magnetic strips 203 are circumferentially arranged along the elastic member 400, so that the mobile phone is stably stressed when being taken down and placed on, and the tubular spring stably drives the first housing 101 to be switched into the first position state.

With reference to FIG. 2 to FIG. 4, in some embodiments, the magnetic attraction structure 300 further comprises a pushing switch (not shown in the figures), a pushing end of the pushing switch is connected with the first housing 101, a main body end of the pushing switch is connected with the second housing 201, the pushing switch is provided with a locked state and an unlocked state, and the first housing 101 is in the first position state and the pushing switch is in the unlocked state; and the pushing switch is in the locked state and the first housing 101 is in the second position state.

It is understandable that, a principle of the pushing switch is similar to a principle of a self-locking switch, or a principle of a push-type ballpoint pen, which will not be repeated herein. When the pushing switch is in the unlocked state, the first housing 101 is far away from the second housing 201, and the first housing 101 is in the first position state. The first housing 101 is pressed towards the second housing 201 to make the pushing switch in the locked state, and the pushing switch may make the first housing 101 maintain in the second position state, thus being convenient for a user to take down the mobile phone. The first housing 101 is pressed again to make the pushing switch in the unlocked state, and the elastic member 400 drives the first housing 101 to return to the first position state.

Optionally, the pushing switch is sleeved in the tubular spring.

With reference to FIG. 2 to FIG. 4, in some embodiments, the magnetic attraction structure 300 further comprises a buckling mechanism, the buckling mechanism comprises a first buckling portion connected with the first housing 101 and a second buckling portion connected with the second housing 201, and when the first housing 101 is in the second position state, the first buckling portion is bucked with the second buckling portion.

With reference to FIG. 2 to FIG. 4, optionally, a shape of the second housing 201 is a plate, and the shape is adapted to a shape of the opening 106. The first buckling portion protrudes from a cavity wall of the accommodating cavity 105, and a plurality of first buckling portions are provided. The second buckling portion is arranged on an edge of the plate of the second housing 201, and a plurality of second buckling portions are provided. When the first housing 101 is in the first position state, the first buckling portions are separated from the second buckling portions respectively. When the first housing 101 is in the second position state, the first buckling portions are buckled with the second buckling portions respectively.

With reference to FIG. 2 to FIG. 4, it is understandable that, when the mobile phone needs to be taken down, the first housing 101 is pressed towards the second housing 201, so that the first buckling portion is buckled with the second buckling portion, thus making the first housing 101 maintain in the second position state, and being convenient to take down the mobile phone. The first housing 101 is pulled again in a direction far away from the first housing 101 to separate the first buckling portion from the second buckling portion, and the elastic member 400 drives the first housing 101 to return to the first position state.

With reference to FIG. 2 to FIG. 4, in some embodiments, the first magnetic attraction assembly 100 further comprises a first magnetic conducting ring 102, the first magnetic strips 103 are arranged at an edge of an inner ring of the first magnetic conducting ring 102 and located between the cavity bottom of the accommodating cavity 105 and the first magnetic conducting ring 102, the first magnetic conducting ring 102 is also provided with an avoidance gap 104 for the second magnetic strip 203 to pass through, and the avoidance gap 104 is arranged between any two adjacent first magnetic strips 103. When the first housing 101 is in the second position state, the second magnetic stripes 203 pass through the avoidance gaps 104 respectively to be spliced with the first magnetic stripes 103, so as to form the magnetic attraction ring 500.

It is understandable that, the first magnetic conducting ring 102 is capable of distributing the magnetic fields of the first magnetic stripes 103 uniformly, which is beneficial for the magnetic connection between the mobile phone and the first magnetic stripes 103.

With reference to FIG. 2 to FIG. 4, in some embodiments, the second magnetic attraction assembly 200 further comprises a second magnetic conducting ring 202 connected with the second housing 201, and the second magnetic stripes 203 are arranged on the second magnetic conducting ring 202. It is understandable that, the second magnetic conducting ring 202 is capable of distributing the magnetic fields of the second magnetic stripes 203 uniformly, which is beneficial for reducing the magnetic connection between the mobile phone and the first magnetic stripes 103.

Optionally, the first magnetic conducting ring 102 and the second magnetic conducting ring 202 are both made of metallic iron.

The present invention further provides a vehicle-mounted bracket, the vehicle-mounted bracket comprises the magnetic attraction structure 300, and a specific structure of the magnetic attraction structure 300 refers to the above embodiments. Because the vehicle-mounted bracket adopts all the technical solutions of all the above embodiments, the vehicle-mounted bracket also has all the beneficial effects brought by the technical solutions of the above embodiments, which will not be repeated herein.

In some embodiments, the vehicle-mounted bracket further comprises a clamping structure, the clamping structure is connected with the magnetic attraction structure 300 and used for fixing the magnetic attraction structure 300 to a control compartment of a vehicle. It is understandable that, the clamping structure is capable of clamping a blade of an air conditioner grille of the vehicle.

The above are merely optional embodiments of the present application, and are not intended to limit the present application. For those skilled in the art, the present application may have various modifications and variations. Any modification, equivalent substitution, improvement, and the like made without departing from the spirit and principle of the present application should fall within the scope of the claims of the present application.

We claim:

1. A magnetic attraction structure, comprising:
a first magnetic attraction assembly, which comprises a first housing provided with an accommodating cavity and a plurality of first magnetic strips arranged in the accommodating cavity, wherein the first housing is provided with an opening communicated with the accommodating cavity, and the first magnetic strips are annularly arranged at intervals in sequence; and
a second magnetic attraction assembly, which comprises a second housing located at the opening and a plurality of second magnetic strips connected with the second housing, wherein the second magnetic strips are annularly arranged at intervals in sequence, and a magnetic pole of the first magnetic strip and a magnetic pole of the second magnetic strip are arranged oppositely;
wherein, the first housing is provided with a first position state and a second position state; when the first housing is in the first position state, the second housing moves towards an exterior of the accommodating cavity by a predetermined distance, so that the first magnetic strips and the second magnetic strips are arranged at intervals along a moving direction; and when the first housing is in the second position state, the first housing moves towards an interior of the accommodating cavity by a predetermined distance, so that the first magnetic strips and the second magnetic strips are spliced into a magnetic attraction ring, and the first magnetic strips and the second magnetic strips are alternately arranged in sequence.

2. The magnetic attraction structure according to claim 1, wherein a shape of the magnetic attraction ring at least comprises one of a circle, an ellipse and a polygon.

3. The magnetic attraction structure according to claim 1, wherein a length of the first magnetic stripe is equal to a length of the second magnetic stripe.

4. The magnetic attraction structure according to claim 1, wherein the magnetic attraction structure further comprises an elastic member with an elastic restoring force, one end of the elastic member is connected with a cavity bottom of the accommodating cavity, and the other end of the elastic member is connected with the second housing; and when the first housing is switched from the first position state to the second position state, the first housing compresses the elastic member.

5. The magnetic attraction structure according to claim 4, wherein the elastic member is a tubular spring, and the first magnetic strips or the second magnetic strips are circumferentially arranged along the elastic member.

6. The magnetic attraction structure according to claim 1, wherein the magnetic attraction structure further comprises a pushing switch, a pushing end of the pushing switch is connected with the first housing, a main body end of the pushing switch is connected with the second housing, the pushing switch is provided with a locked state and an unlocked state, and the first housing is in the first position state and the pushing switch is in the unlocked state; and the pushing switch is in the locked state and the first housing is in the second position state.

7. The magnetic attraction structure according to claim 1, wherein the magnetic attraction structure further comprises a buckling mechanism, the buckling mechanism comprises a first buckling portion connected with the first housing and a second buckling portion connected with the second housing, and when the first housing is in the second position state, the first buckling portion is bucked with the second buckling portion.

8. The magnetic attraction structure according to claim 1, wherein the first magnetic attraction assembly further comprises a first magnetic conducting ring, the first magnetic strips are arranged at an edge of an inner ring of the first magnetic conducting ring and located between the cavity bottom of the accommodating cavity and the first magnetic conducting ring, the first magnetic conducting ring is also provided with an avoidance gap for the second magnetic strip to pass through, and the avoidance gap is arranged between any two adjacent first magnetic strips.

9. The magnetic attraction structure according to claim 1, wherein the second magnetic attraction assembly further comprises a second magnetic conducting ring connected with the second housing, and the second magnetic stripes are arranged on the second magnetic conducting ring.

10. A vehicle-mounted bracket, comprising the magnetic attraction structure according to claim 1.
